(19) United States
(12) Patent Application Publication
(10) Pub. No.: US 2024/0348968 A1
(43) Pub. Date: Oct. 17, 2024

(54) LOUD-SPEAKING APPARATUS FOR HEAD-MOUNTED DEVICE AND HEAD-MOUNTED DEVICE WITH SAME

(71) Applicant: Beijing Zitiao Network Technology Co., Ltd., Beijing (CN)

(72) Inventors: Haigang LI, Beijing (CN); Zishang WANG, Beijing (CN)

(21) Appl. No.: 18/705,984

(22) PCT Filed: Dec. 30, 2022
(86) PCT No.: PCT/CN2022/143733

§ 371 Date: Apr. 29, 2024

(30) Foreign Application Priority Data
Jan. 14, 2022 (CN) 202210043228.3

(51) Int. Cl. H04R 1/10

(52) U.S. Cl. CPC H04R 1/1075; H04R 2460/11

(57) ABSTRACT

Disclosed are a loud-speaking apparatus for a head-mounted device and a head-mounted device with the same, wherein, the loud-speaking apparatus includes: a shell assembly and a loud-speaking assembly, the mounting cavity, a front sound cavity and a rear sound cavity are arranged in the shell assembly, the mounting cavity includes a plurality of sub-cavities, each sub-cavity is communicated with the front sound cavity and the rear sound cavity, the loud-speaking assembly includes a plurality of loudspeakers, the plurality of loudspeakers is disposed in the plurality of sub-cavities in one-to-one correspondence, so that each sub-cavity is provided with one corresponding loudspeaker.

### CROSS-REFERENCE TO RELATED APPLICATIONS

The present disclosure is filed on the basis of a Chinese patent application with application number 202210043228.3 and a filing date of 2022 Jan. 14, and claims the priority of the Chinese patent application, and the entire contents of the Chinese patent application are hereby incorporated into the present disclosure for reference.

### FIELD

The present disclosure relates to the technical field of head-mounted devices, and in particular, to a loud-speaking apparatus for a head-mounted device and a head-mounted device with the same.

### BACKGROUND

Some head-mounted devices in the related art are each provided with a loud-speaking unit. The loud-speaking unit adopts a single-speaker design, that is, each loud-speaking unit includes only one loudspeaker. In addition, a front sound cavity and a rear sound cavity that match the loudspeaker are provided. The loud-speaking unit is disposed in a middle shell of the device, and transmits sound to surrounding of a human ear through a sound guide tube. However, in the length direction of the sound guide tube, the quality of the sound gradually reduces. In addition, there are some other head-mounted devices whose loud-speaking units are disposed in binders. However, dimensions of a loud-speaking unit are limited due to a limitation on a size of a corresponding binder. As a result, an acoustic effect is negatively affected.

### SUMMARY

The present disclosure is intended to solve at least one of technical problems in the prior art. In view of this, the present disclosure aims to provide a loud-speaking apparatus for a head-mounted device. The loud-speaking apparatus has improved acoustic performance in a limited space, and shortens the sound transmitting distance.

The present disclosure further provides a head-mounted device with the loud-speaking apparatus.

A loud-speaking apparatus for a head-mounted device according to the first embodiment of the present disclosure, comprising: a shell assembly, provided with a mounting cavity, a front sound cavity and a rear sound cavity, the mounting cavity comprising a plurality of sub-cavities, and each sub-cavity being communicated with the front sound cavity and the rear sound cavity; and a loud-speaking assembly comprising a plurality of loudspeakers, the plurality of loudspeakers being disposed in the plurality of sub-cavities in one-to-one correspondence, so that each sub-cavity is provided with one corresponding loudspeaker.

According to the loud-speaking apparatus for a head-mounted device provided in this embodiment of the present disclosure, there are a plurality of loudspeakers that share a front sound cavity and a plurality of loudspeakers that share a rear sound cavity, so that acoustic performance in a limited space can be improved, and a sound transmitting distance can be shortened.

In some embodiments, two length ends of the shell assembly are a first end and a second end, respectively, the front sound cavity is disposed on one side of the mounting cavity proximal to the first end; the rear sound cavity is disposed on one side of the mounting cavity proximal to the second end, and in a length direction of the shell assembly, a length of the front sound cavity is less than a length of the rear sound cavity.

In some embodiments, the shell assembly is provided with a sound output hole communicated with the front sound cavity, and the sound output hole is formed in an end surface of the first end.

In some embodiments, a center of the sound output hole is disposed at a position deviated from a width center and/or a thickness center of the first end, and the sound output hole accounts for ⅓ or more of a length of the first end.

In some embodiments, the plurality of sub-cavities in the mounting cavity is sequentially arranged in a width direction of the shell assembly, so that the plurality of loudspeakers is flatly laid in the shell assembly side by side.

In some embodiments, the shell assembly comprises a top wall and a bottom wall that are disposed oppositely in a thickness direction, the mounting cavity comprises a top channel between the loud-speaking assembly and the top wall, each sub-cavity is communicated with the rear sound cavity through the top channel, the mounting cavity further comprises a bottom channel between the loud-speaking assembly and the bottom wall, and each sub-cavity is communicated with the front sound cavity through the bottom channel.

In some embodiments, the shell assembly comprises a bracket comprising a frame portion and a sound output portion, the frame portion defines a plurality of first limiting grooves, the plurality of loudspeakers is disposed in the plurality of first limiting grooves in a limited and matched manner in one-to-one correspondence, and the sound output portion defines the front sound cavity.

In some embodiments, the shell assembly further comprises a housing, in which the bracket is disposed, the housing independently defines the rear sound cavity, and the housing and the bracket jointly define the mounting cavity.

In some embodiments, the shell assembly is provided with a sound output hole communicated with the front sound cavity and an air vent communicated with the rear sound cavity, and both the sound output hole and the air vent are formed in the housing.

In some embodiments, the housing comprises a base and a cover plate, the base defines a mounting space having an opening on one thickness side, the mounting space is provided with a second limiting groove, the bracket is disposed in the mounting space and is positioned in the second limiting groove in a matched manner, and the cover plate covers an open side of the base, so that the cover plate and the base jointly define the rear sound cavity.

In some embodiments, the base is provided with a projecting portion that projects in a direction distal from the cover plate; the second limiting groove comprises a partial recess disposed corresponding to the projecting portion, and the sound output portion is disposed in the partial recess in a matched manner.

In some embodiments, the loud-speaking apparatus comprises two loudspeakers, and the two loudspeakers are the same as or different from each other.

The head-mounted device according to the embodiment in the second aspect of the present disclosure includes the loud-speaking apparatus for a head-mounted device according to the embodiment in the first aspect of the present disclosure.

The head-mounted device according to this embodiment of the present disclosure is provided with the loud-speaking apparatus for a head-mounted device according to the embodiment in the first aspect, so that overall acoustic performance of the head-mounted device is improved.

In some embodiments, the head-mounted device comprises a lateral binder, and the loud-speaking apparatus is disposed on the lateral binder.

Additional aspects and advantages of the present disclosure will be given in part in the description below, and some will become apparent from the description below or become known through the practice of this disclosure.

### BRIEF DESCRIPTION OF THE DRAWINGS

FIG. 1 is a perspective view of a loud-speaking apparatus according to an embodiment of the present disclosure;

FIG. 2 is an exploded view of the loud-speaking apparatus shown in FIG. 1;

FIG. 3 is a sectional view of the loud-speaking apparatus shown in FIG. 1;

FIG. 4 is another sectional view of the loud-speaking apparatus shown in FIG. 1;

FIG. 5 is a perspective view of a bracket shown in FIG. 2; and

FIG. 6 is a perspective view of a base shown in FIG. 2.

### REFERENCE NUMERALS

loud-speaking apparatus 1000; length direction F1; width direction F2; thickness direction F3; shell assembly 100; first end 1a; second end 1b; top wall 1c; bottom wall 1d; mounting cavity 11; sub-cavity 111; top channel 112; bottom channel 113; front sound cavity 12; rear sound cavity 13; sound output hole 14; air vent 15; bracket 2; frame portion 21; first limiting groove 211; separating rib 212; frame 213; sound output portion 22; housing 3; base 31; mounting space 311; second limiting groove 312; projecting portion 313; partial recess 314; cover plate 32; loud-speaking assembly 200; and loudspeaker 4.

### DETAILED DESCRIPTION

The embodiments of the present disclosure are described in detail below, and examples of the embodiments are shown in the accompanying drawings wherein the same or similar designations from beginning to end indicate the same or similar elements or elements having the same or similar functions. The embodiments described below by reference to the drawings are illustrative and are intended to be used in the interpretation of the present disclosure and should not be construed as limiting the present disclosure.

The disclosure below provides a number of different embodiments or examples to implement the different structures of the present disclosure. In order to simplify the disclosure of the present disclosure, the parts and settings of a specific example are described below. Of course, they are only examples and are not intended to limit this disclosure. In addition, the disclosure may refer to numbers and/or letters repeatedly in different examples. This repetition is for the sake of simplicity and clarity and does not in itself indicate the relationship between the various embodiments and/or settings discussed. In addition, the present disclosure provides examples of various specific processes and materials, but those of ordinary skill in the art may be aware of the applicability of other processes and/or the use of other materials.

With reference to the accompanying drawings, the following describes a loud-speaking apparatus 1000 for a head-mounted device according to an embodiment in the first aspect of the present disclosure.

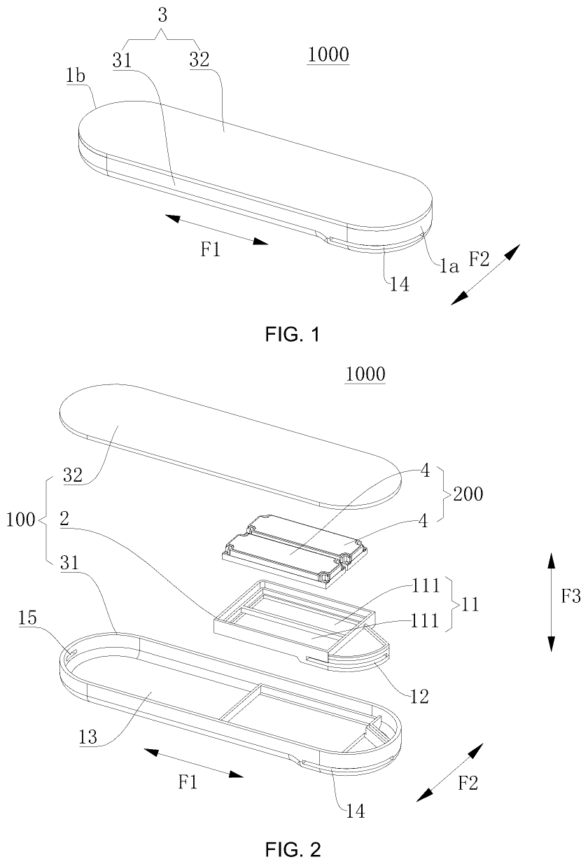

As shown in FIG. 1 and FIG. 2, the loud-speaking apparatus 1000 may include a shell assembly 100 and a loud-speaking assembly 200. A mounting cavity 11, a front sound cavity 12 and a rear sound cavity 13 are arranged in the shell assembly 100. The mounting cavity 11 includes a plurality of sub-cavities 111. Each sub-cavity 111 is communicated with the front sound cavity 12 and the rear sound cavity 13. The loud-speaking assembly 200 includes a plurality of loudspeakers 4. The plurality of loudspeakers 4 is disposed in the plurality of sub-cavities 111 in one-to-one correspondence, so that each sub-cavity 111 is provided with one corresponding loudspeaker 4.

Therefore, by providing a plurality of loudspeakers 4 that shares a front sound cavity 12 and a plurality of loudspeakers 4 that shares a rear sound cavity 13, overall power and an acoustic effect of the loud-speaking assembly 200 can be improved. In addition, compared with a case in which a plurality of loud-speaking units is provided simultaneously, each loud-speaking unit includes a loudspeaker, as well as a front sound cavity and a rear sound cavity that cooperate with the loudspeaker. According to the loud-speaking apparatus 1000 in this embodiment of the present disclosure, because the plurality of loudspeakers 4 shares the front sound cavity 12 and the rear sound cavity 13, overall space occupied by the loud-speaking apparatus 1000 may be smaller, so that the loud-speaking apparatus 1000 is more applicable to the position having the limited space. In addition, compared to a case in which a plurality of loud-speaking units is mounted separately, assembling steps can be decreased; an assembling effect can be improved; and maintenance and replacement are facilitated.

In summary, according to the loud-speaking apparatus 1000 in this embodiment of the present disclosure, because the loud-speaking apparatus 1000 includes the plurality of loudspeakers 4 that shares a sound cavity, acoustic performance in a limited space can be improved, and a sound transmitting distance can be shortened. It should be noted that when the loud-speaking apparatus 1000 according to this embodiment of the present disclosure can be selectively disposed in a lateral binder, the distance from the loud-speaking apparatus 1000 to a human ear can be further shortened, so that a sound guide tube can be eliminated. This reduces costs, simplifies a structure, and improves sound quality. It may be understood that sound quality can be better improved when the loud-speaking apparatus 1000 is disposed at the position of the lateral binder near a human ear. Certainly, the present disclosure is not limited thereto. In other embodiments of the present disclosure, the loud-speaking apparatus 1000 may be disposed in a top binder or a middle shell of the head-mounted device or at another position. Details are not described herein again.

It should be noted that in the loud-speaking apparatus 1000 according to this embodiment of the present disclosure, a specific type of each loudspeaker 4 is not limited and may be selected according to actual needs. In addition, specification parameters of the plurality of loudspeakers 4 may be the same or different, so that a required acoustic effect can be acquired via cooperation between the loudspeakers as required.

For example, in some specific examples of the present disclosure, as shown in FIG. 2, the loud-speaking apparatus 1000 includes two loudspeakers 4. The two loudspeakers 4 are the same, that is, shape dimensions of the two loudspeakers 4 are consistent, and their specification parameters are also consistent, so that the loudspeakers are interchangeable. This makes mounting more convenient and improves assembling efficiency. Moreover, on the premise that an acoustic effect is improved, overall dimensions of the loud-speaking apparatus 1000 can be reduced. This better facilitates use in a limited space.

In some embodiments of the present disclosure, work control for the two loudspeakers 4 can be designed according to actual requirements. For example, in some embodiments, the two loudspeakers 4 may be set to work simultaneously. For another example, in some other embodiments, alternatively, the two loudspeakers 4 may be set as follows: selecting either of the loudspeakers 4 to be switched to work independently, or enabling the two loudspeakers 4 to work simultaneously, so that different actual needs can be satisfied.

In some embodiments of the present disclosure, as shown in FIG. 1 and FIG. 2, two length ends of the shell assembly 100 are a first end 1a and a second end 1b, respectively. The front sound cavity 12 is disposed on one side of the mounting cavity 11 proximal to the first end 1a. The rear sound cavity 13 is disposed on one side of the mounting cavity 11 proximal to the second end 1b. In the length direction F1 of the shell assembly 100, the length of the front sound cavity 12 is less than that of the rear sound cavity 13. In other words, in the length direction F1 of the shell assembly 100, the front sound cavity 12 and the rear sound cavity 13 are disposed on two sides of the loud-speaking assembly 200, respectively. The length of the front sound cavity 12 is less than that of the rear sound cavity 13. The two length ends of the shell assembly 100 are the first end 1a proximal to the front sound cavity 12 and the second end 1b proximal to the rear sound cavity 13, respectively.

Therefore, the long-strip-shaped loud-speaking apparatus 1000 has a small overall structural shape, and occupies a small space, thereby being applicable to longer and narrower spaces such as a binder.

In some embodiments of the present disclosure, as shown in FIG. 1 and FIG. 2, the shell assembly 100 is provided with a sound output hole 14 communicated with the front sound cavity 12. The sound output hole 14 is formed in an end surface of the first end 1a. Therefore, it can better ensure that the distance from the loud-speaking assembly 200 to the sound output hole 14 is shorter. This further improves a hearing effect of a human ear.

In some embodiments of the present disclosure, as shown in FIG. 1 and FIG. 2, the center of the sound output hole 14 is disposed at a position deviated from the width center and/or the thickness center of the first end 1a; and the sound output hole 14 accounts for ⅓ or more of the length of the first end 1a. Therefore, in one aspect, it can ensure that the size of the sound output hole 14 is larger, which can improve a sound output effect. In another aspect, the sound output hole 14 is disposed at a position proximal to one width side and/or one thickness side of the shell assembly 100, which can further shorten the distance from the sound output hole 14 to a human ear. For example, when the loud-speaking apparatus 1000 is used in a lateral binder, the lateral binder is usually disposed above a human ear; one width side of the lateral binder is proximal to the human ear; and the other width side of the lateral binder is proximal to a top of a head. Therefore, the distance from the sound output hole 14 to the human ear can be further shortened by disposing the sound output hole 14 at the position proximal to one width side and/or one thickness side of the shell assembly 100. In addition, it should be noted that “⅓ or more” includes ⅓ and more than ⅓. For example, “⅓ or more” may be ⅓, 1.1/3, 1.2/3, 1.3/3, 1.4/3, 1.5/3, 1.6/3, 1.7/3, 1.8/3, 1.9/3, ⅔, 2.1/3, or the like. Details are not described herein again.

In some embodiments of the present disclosure, as shown in FIG. 1 and FIG. 2, the shell assembly 100 is provided with an air vent 15 communicated with the rear sound cavity 13. The air vent 15 may be formed in an end surface of the second end 1b, and an opening area of the air vent 15 is smaller than that of the sound output hole 14, so that an acoustic effect can be ensured, and processing is convenient. Optionally, the center of the air vent 15 is disposed at the width center of the second end 1b, so that processing is convenient, and an acoustic effect can be improved.

In some embodiments of the present disclosure, as shown in FIG. 1 and FIG. 2, the plurality of sub-cavities 111 in the mounting cavity 11 is sequentially arranged in the width direction F2 of the shell assembly 100. In this way, the plurality of sub-cavities 111 is disposed side by side, the front sound cavity 12 is disposed on the same side of the plurality of sub-cavities 111, and the rear sound cavity 13 is also disposed on the same side of the plurality of sub-cavities 111, so that the plurality of sub-cavities 111 can be easily communicated with the front sound cavity 12 at the same time, and may also be easily communicated with the rear sound cavity 13 at the same time. Therefore, a structure and a sound transmission path can be simplified, and an acoustic effect can be further improved.

In addition, it may be understood that the plurality of loudspeakers 4 may be flatly laid in the shell assembly 100 side by side by arranging the mounting cavity 11 as described above, so that the plurality of loudspeakers 4 can make sounds without affecting each other and interfering with each other, which improves an overall acoustic effect. Moreover, the height of the loud-speaking assembly 200 in the thickness direction F3 of the shell assembly 100 can be reduced to reduce the overall thickness of the loud-speaking apparatus 1000, so that the loud-speaking apparatus 1000 is applicable to longer and narrower spaces such as a binder. Certainly, the present disclosure is not limited thereto. In other embodiments of the present disclosure, the loudspeakers 4 may alternatively be disposed in a manner of being overlapped in the thickness direction F3 of the shell assembly 100, or disposed in another manner. Details are not described herein again.

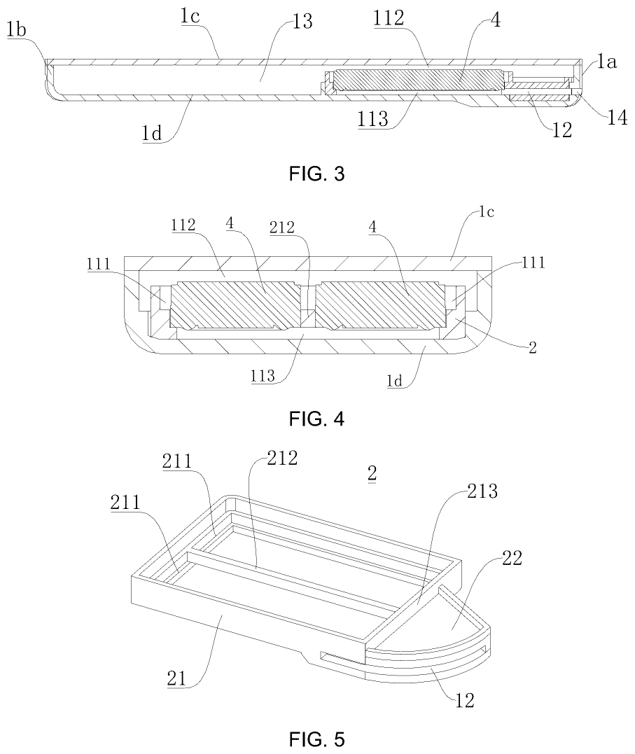

Further, when the plurality of loudspeakers 4 is flatly laid in the shell assembly 100 side by side, in some embodiments, with reference to FIG. 3 and FIG. 4, the shell assembly 100 includes a top wall 1c and a bottom wall 1d that are disposed oppositely in the thickness direction F3. The mounting cavity 11 includes a top channel 112 between the loud-speaking assembly 200 and the top wall 1c. Each sub-cavity 111 is communicated with the rear sound cavity 13 through the top channel 112. The mounting cavity 11 further includes a bottom channel 113 between the loud-speaking assembly 200 and the bottom wall 1d. Each sub-cavity 111 is communicated with the front sound cavity 12 through the bottom channel 113. Therefore, the structure is simple, and can simply and effectively ensure that the respective sub-cavities 111 are simultaneously communicated with the front sound cavity 12 and are simultaneously communicated with the rear sound cavity 13, and the communication effect is good, thereby excellently improving the acoustic effect.

In some embodiments of the present disclosure, as shown in FIG. 2 and FIG. 5, the shell assembly 100 may include a bracket 2. The bracket 2 includes a frame portion 21 and a sound output portion 22. The frame portion 21 defines a plurality of first limiting grooves 211. The plurality of loudspeakers 4 is disposed in the plurality of first limiting grooves 211 in a limited and matched manner in one-to-one correspondence. The sound output portion 22 defines the front sound cavity 12. Therefore, the plurality of loudspeakers 4 can be mounted and fixed by using the bracket 2, so that the assembling efficiency is improved. In addition, both the first limiting grooves 211 and the front sound cavity 12 are disposed on the same bracket 2, so that the stable relative positions of the respective loudspeakers 4 and the front sound cavity 12 can be ensured, thereby ensuring and improving the acoustic effect.

For example, in some specific examples, as shown in FIG. 5, the frame portion 21 may include a frame 213 and a separating rib 212. The separating rib 212 is disposed in the frame 213. The plurality of first limiting grooves 211 is defined by the separating rib 212 and the frame 213 jointly. The separating rib 212 may limit two adjacent loudspeakers 4, to ensure that there is a particular distance therebetween. Therefore, the structure is simple, and the processing is convenient. Moreover, a sound output portion 22 is disposed on an outer side of a frame edge of the frame 213. The front sound cavity 12 in the sound output portion 22 is communicated with each first limiting groove 211 through a communication opening in the frame edge. An opening is formed in an outer surface of the sound output portion 22. The opening faces the sound output hole 14, so that the front sound cavity 12 can output a sound through the sound output hole 14. The shape of the first limiting groove 211 may match that of the corresponding loudspeaker 4, so that a limiting effect can be improved; design, processing and assembling are convenient; and structural compactness is improved.

Further, as shown in FIG. 2, the shell assembly 100 may further include a housing 3. The bracket 2 is disposed in the housing 3. The housing 3 independently defines the rear sound cavity 13. The housing 3 and the bracket 2 jointly define the mounting cavity 11. Therefore, the mounting cavity 11, the front sound cavity 12 and the rear sound cavity 13 can be acquired simply and effectively; the shell assembly 100 is simple in structure and convenient to process and assemble; and it is convenient to assemble the loud-speaking assembly 200 to the shell assembly 100.

Further, as shown in FIG. 2, the shell assembly 100 is provided with the sound output hole 14 communicated with the front sound cavity 12 and an air vent 15 communicated with the rear sound cavity 13. Both the sound output hole 14 and the air vent 15 may be formed in the housing 3. Therefore, the sound output hole 14 and the air vent 15 can be acquired simply and effectively; and the shell assembly 100 is simple in structure and convenient to process and assemble.

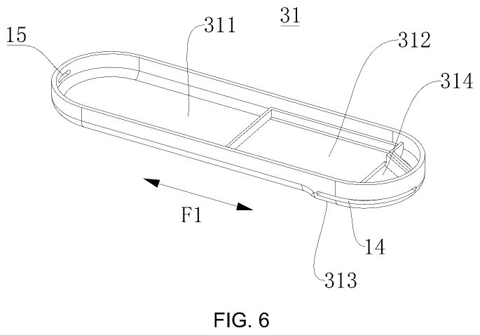

Optionally, as shown in FIG. 2 and FIG. 6, the housing 3 may include a base 31 and a cover plate 32. The base 31 defines a mounting space 311 having an opening on one thickness side. A second limiting groove 312 is formed in the mounting space 311. The bracket 2 is disposed in the mounting space 311 and is positioned in the second limiting groove 312 in a matched manner. The cover plate 32 covers the open side of the base 31, so that the cover plate 32 and the base 31 jointly define the rear sound cavity 13. Therefore, the housing 3 is simple in structure and convenient to process; and the stable and reliable relative positions of the bracket 2 and the housing 3 can be ensured by using the second limiting groove 312, thereby ensuring the acoustic effect. Moreover, the housing 3 having this structure is simple in composition, thereby being convenient to process and assemble, and facilitating assembling of the bracket 2. The shape of the second limiting groove 312 may match that of the bracket 2, so that a limiting effect can be improved; design, processing and assembly are convenient; and structural compactness is improved.

For example, during assembling, the plurality of loudspeakers 4 may be respectively fixed in the plurality of first limiting grooves 211 of the bracket 2 to acquire a semi-finished assembly; the semi-finished assembly is mounted in the second limiting groove 312 of the base 31 to acquire the front sound cavity 12; and then, the cover plate 32 covers the opening of the base 31, so that the base 31 and the cover plate 32 jointly define the rear sound cavity 13.

In some embodiments, the base 31 is provided with a projecting portion 313 that projects in a direction distal from the cover plate 32; the second limiting groove 312 includes a partial recess 314 disposed corresponding to the projecting portion 313; and the sound output portion 22 is disposed in the partial recess 314 in a matched manner. Therefore, the position of the sound output portion 22 can be lowered, which ensures that the front sound cavity 12 can be disposed near one thickness side of the shell assembly 100. This facilitates disposing the sound output hole 14 near one thickness side of the shell assembly 100, so that the distance from the sound output hole 14 to a human ear can be better shortened.

The head-mounted device according to the embodiment in the second aspect of the present disclosure is described below.

The head-mounted device according to this embodiment of the present disclosure includes the loud-speaking apparatus 1000 of the head-mounted device according to the foregoing embodiment. Therefore, according to the head-mounted device provided in this embodiment of the present disclosure, by providing the loud-speaking apparatus 1000 including a plurality of loudspeakers 4 that shares a sound cavity according to this embodiment of the present disclosure, the acoustic performance in a limited space can be improved, and a sound transmitting distance can be shortened. This facilitates ensuring sound quality of the head-mounted device, thereby improving user experience.

It should be noted that a specific type of the head-mounted device is not limited. For example, the head-mounted device may be a VR/AR/XR device or the like. In some specific examples of the present disclosure, the head-mounted device may include a lateral binder. The loud-speaking apparatus 1000 is disposed in the lateral binder, so that the distance from the loud-speaking apparatus 1000 to a human ear can be further shortened; and then, a sound guide tube can be eliminated. This reduces costs, simplifies the structure, and improves the sound quality. It may be understood that sound quality can be better improved when the loud-speaking apparatus 1000 is disposed at the position of the lateral binder near a human ear.

In addition, it may be understood that the lateral binder may include two binder segments on the left and right sides of a human head. Each binder segment is provided with the loud-speaking apparatus 1000, so that both ears on two sides can hear sounds. This improves user experience. Certainly, the present disclosure is not limited thereto. In other embodiments of the present disclosure, the loud-speaking apparatus 1000 may alternatively be disposed in a top binder or a middle shell of the head-mounted device or at another position. Details are not described herein again.

In addition, after the type of the head-mounted device according to this embodiment of the present disclosure is determined, other compositions and operations of the head-mounted device are all known to those of ordinary skill in the art. Details are not described herein.

In the description of the present disclosure, it is understood that the terms “length”, “width”, “thickness”, etc., indicate the orientation or positional relationship based on the orientation or positional relationship shown in the drawing, and are only for the convenience of description and simplification of the description, and do not indicate or imply that the device or element referred to must have a specific orientation, be constructed and operated in a particular orientation, and therefore cannot be construed as limiting the present disclosure.

In addition, the terms “first” and “second” are used for descriptive purposes only and should not be construed as indicating or implying relative importance or implying the number of technical features indicated. Thus, defining the “first” and “second” features may explicitly or implicitly include one or more of these features. In the description of this disclosure, “multiple” means two or more of them, unless otherwise expressly and specifically qualified.

In this disclosure, unless otherwise expressly specified or qualified, the terms “mounted”, “connected”, “connected”, “fixed”, etc., shall be construed broadly, for example, as fixed connections, detachable connections, or integral, directly or indirectly through an intermediate medium, or within two elements or the interaction between two elements. For those of ordinary skill in the art, the specific meaning of the above terms in the present disclosure may be understood on a case-by-case basis.

In the description of this specification, references to the terms “one embodiment”, “some embodiments”, “examples”, “specific examples”, or “some examples”, etc., are intended to mean the specific features, structures, materials, or features described in conjunction with the embodiments or examples contained in at least one embodiment or example of the present disclosure. In this specification, the schematic formulation of the above terms does not have to be for the same embodiments or examples. Furthermore, the specific features, structures, materials, or features described may be combined in an appropriate manner in any one or more embodiments or examples. In addition, without contradicting each other, those skilled in the art may combine and combine the different embodiments or examples described in this specification and the features of the different embodiments or examples.

Notwithstanding the embodiments of the present disclosure shown and described, it may be understood by a person of ordinary skill in the art that a variety of variations, modifications, substitutions and variants may be made to these embodiments without departing from the principle and purpose of the present disclosure, and the scope of the present disclosure is limited by the claims and their equivalents.

1. A loud-speaking apparatus for a head-mounted device, the loud-speaking apparatus comprising:
a shell assembly provided with a mounting cavity, a front sound cavity and a rear sound cavity, the mounting cavity comprising a plurality of sub-cavities, and each sub-cavity being communicated with the front sound cavity and the rear sound cavity; and
a loud-speaking assembly comprising a plurality of loudspeakers, the plurality of loudspeakers being disposed in the plurality of sub-cavities in one-to-one correspondence, so that each sub-cavity is provided with one corresponding loudspeaker.

2. The loud-speaking apparatus for a head-mounted device according to claim 1, wherein two length ends of the shell assembly are a first end and a second end, respectively, the front sound cavity is disposed on one side of the mounting cavity proximal to the first end; the rear sound cavity is disposed on one side of the mounting cavity proximal to the second end, and in a length direction of the shell assembly, a length of the front sound cavity is less than a length of the rear sound cavity.

3. The loud-speaking apparatus for a head-mounted device according to claim 2, wherein the shell assembly is provided with a sound output hole communicated with the front sound cavity, and the sound output hole is formed in an end surface of the first end.

4. The loud-speaking apparatus for a head-mounted device according to claim 3, wherein a center of the sound output hole is disposed at a position deviated from a width center and/or a thickness center of the first end, and the sound output hole accounts for ⅓ or more of a length of the first end.

5. The loud-speaking apparatus for a head-mounted device according to claim 2, wherein the plurality of sub-cavities in the mounting cavity is sequentially arranged in a width direction of the shell assembly, so that the plurality of loudspeakers is flatly laid in the shell assembly side by side.

6. The loud-speaking apparatus for a head-mounted device according to claim 5, wherein the shell assembly comprises a top wall and a bottom wall that are disposed oppositely in a thickness direction, the mounting cavity comprises a top channel between the loud-speaking assembly and the top wall, each sub-cavity is communicated with the rear sound cavity through the top channel, the mounting cavity further comprises a bottom channel between the loud-speaking assembly and the bottom wall, and each sub-cavity is communicated with the front sound cavity through the bottom channel.

7. The loud-speaking apparatus for a head-mounted device according to claim 1, wherein the shell assembly comprises a bracket comprising a frame portion and a sound output portion, the frame portion defines a plurality of first limiting grooves, the plurality of loudspeakers is disposed in the plurality of first limiting grooves in a limited and matched manner in one-to-one correspondence, and the sound output portion defines the front sound cavity.

8. The loud-speaking apparatus for a head-mounted device according to claim 7, wherein the shell assembly further comprises a housing, in which the bracket is disposed, the housing independently defines the rear sound cavity, and the housing and the bracket jointly define the mounting cavity.

9. The loud-speaking apparatus for a head-mounted device according to claim 8, wherein the shell assembly is provided with a sound output hole communicated with the front sound cavity and an air vent communicated with the rear sound cavity, and both the sound output hole and the air vent are formed in the housing.

10. The loud-speaking apparatus for a head-mounted device according to claim 8, wherein the housing comprises a base and a cover plate, the base defines a mounting space having an opening on one thickness side, the mounting space is provided with a second limiting groove, the bracket is disposed in the mounting space and is positioned in the second limiting groove in a matched manner, and the cover plate covers an open side of the base, so that the cover plate and the base jointly define the rear sound cavity.

11. The loud-speaking apparatus for a head-mounted device according to claim 10, wherein the base is provided with a projecting portion that projects in a direction distal from the cover plate; the second limiting groove comprises a partial recess disposed corresponding to the projecting portion, and the sound output portion is disposed in the partial recess in a matched manner.

12. The loud-speaking apparatus for a head-mounted device according to claim 1, wherein the loud-speaking apparatus comprises two loudspeakers, and the two loudspeakers are the same as or different from each other.

13. A head-mounted device, comprising a loud-speaking apparatus for a head-mounted device, the loud-speaking apparatus comprising:
a shell assembly provided with a mounting cavity, a front sound cavity and a rear sound cavity, the mounting cavity comprising a plurality of sub-cavities, and each sub-cavity being communicated with the front sound cavity and the rear sound cavity; and
a loud-speaking assembly comprising a plurality of loudspeakers, the plurality of loudspeakers being disposed in the plurality of sub-cavities in one-to-one correspondence, so that each sub-cavity is provided with one corresponding loudspeaker.

14. The head-mounted device according to claim 13, wherein the head-mounted device comprises a lateral binder, and the loud-speaking apparatus is disposed on the lateral binder.

15. The head-mounted device of claim 13, wherein two length ends of the shell assembly are a first end and a second end, respectively, the front sound cavity is disposed on one side of the mounting cavity proximal to the first end; the rear sound cavity is disposed on one side of the mounting cavity proximal to the second end, and in a length direction of the shell assembly, a length of the front sound cavity is less than a length of the rear sound cavity.

16. The head-mounted device of claim 15, wherein the shell assembly is provided with a sound output hole communicated with the front sound cavity, and the sound output hole is formed in an end surface of the first end.

17. The head-mounted device of claim 16, wherein a center of the sound output hole is disposed at a position deviated from a width center and/or a thickness center of the first end, and the sound output hole accounts for ⅓ or more of a length of the first end.

18. The head-mounted device of claim 15, wherein the plurality of sub-cavities in the mounting cavity is sequentially arranged in a width direction of the shell assembly, so that the plurality of loudspeakers is flatly laid in the shell assembly side by side.

19. The head-mounted device of claim 18, wherein the shell assembly comprises a top wall and a bottom wall that are disposed oppositely in a thickness direction, the mounting cavity comprises a top channel between the loud-speaking assembly and the top wall, each sub-cavity is communicated with the rear sound cavity through the top channel, the mounting cavity further comprises a bottom channel between the loud-speaking assembly and the bottom wall, and each sub-cavity is communicated with the front sound cavity through the bottom channel.

20. The head-mounted device of claim 13, wherein the shell assembly comprises a bracket comprising a frame portion and a sound output portion, the frame portion defines a plurality of first limiting grooves, the plurality of loudspeakers is disposed in the plurality of first limiting grooves in a limited and matched manner in one-to-one correspondence, and the sound output portion defines the front sound cavity.
